(19) United States
(12) Patent Application Publication
(10) Pub. No.: US 2008/0054139 A1
(43) Pub. Date: Mar. 6, 2008

(54) Handbag hanger

(76) Inventor: Eva Fabbri, Hallandale Beach, FL (US)

Correspondence Address: EVA FABBRL, 1801 SOUTH OCEAN DR., 3 334, HALLANDALE BEACH, FL, 33009, US

(21) Appl. No.: 11/447,656

(22) Filed: Jun. 6, 2006

(51) Int. Cl. A47F 5/00; F16B 45/00

(52) U.S. Cl. 248/215; 248/304

(57) ABSTRACT

This new devise is a bag hanger. When in use, protects the user's belongings from bacteria that abound on floors, specially on public places, it also protects them from snatchers since it is close to its owner Seating on top of a table or any other flat surface can holds large or small bags, yet, so small its self that fits in an evening purse or a women wallet. Strong but elegant, made of pure bronze,and sprayed with lacquer to prevent tarnish.

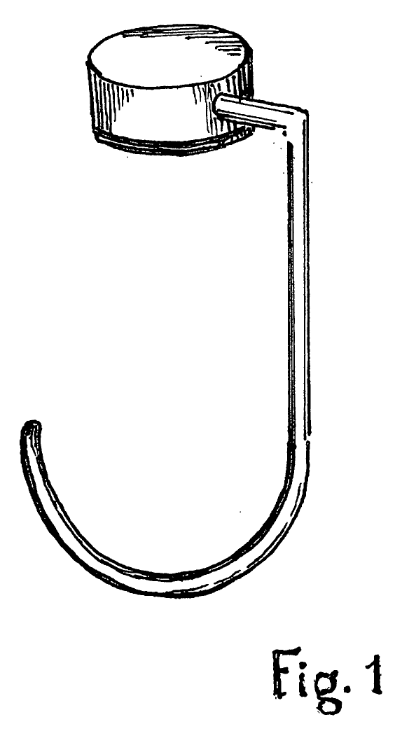

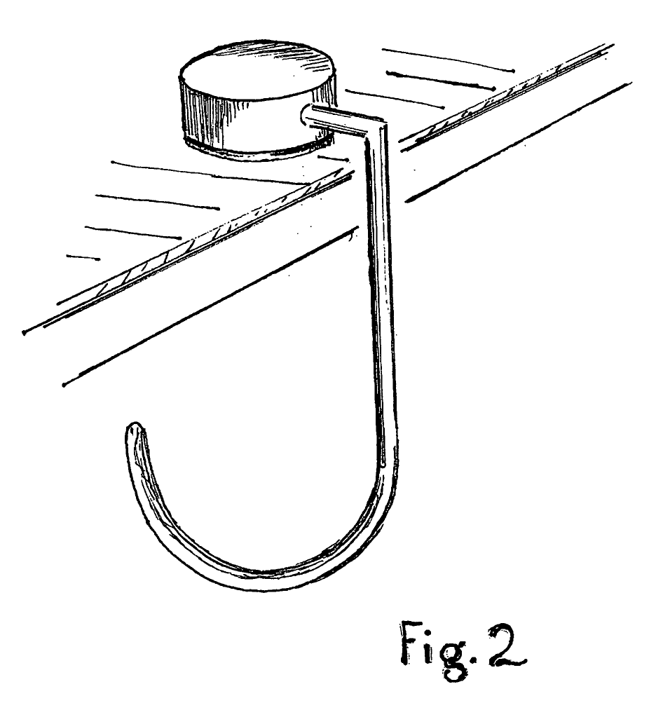

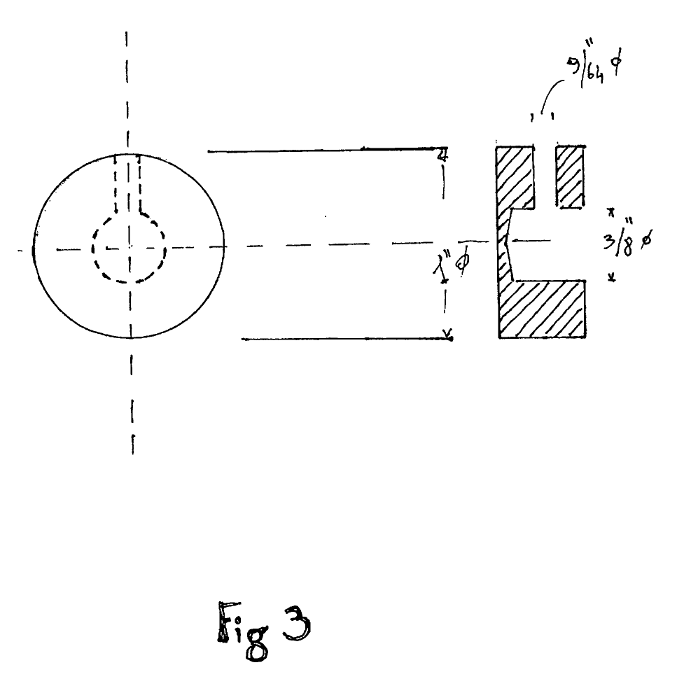

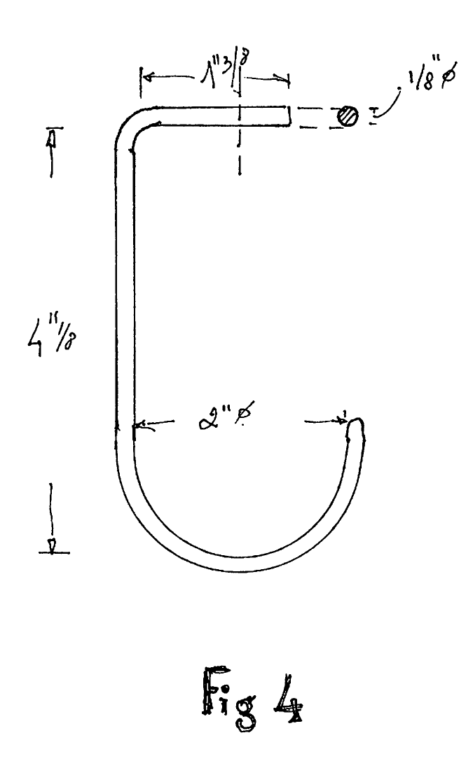

What I have invented is a devise to hang a bag.

It is a 1″ round object with one hole on the side and another on the back

A 8″ piece of round rod will be inserted on the side hole.

Trough the back hole a drop of led will secure the rod from slide out but still give it a 360 of free movement

The rod then is bend at one end 1½″ on a 90 to give space from the edge of the table, the other end is curve on a hook shape where the bag hangs its self.

It is made of pure casting bronze with a lacquer finish to protected it from tarnish.

On the back then will go a 1″ round piece of rubber to cover the hole and also to avoid the devise to slide from the surface where it stands

1. I Eva Fabbri, claim a devise that I had invented and developed as a new bag hanger, in witch any bag of a size of up to 10″×16″×14″ and with a weigh of up to 3 pounds, can be securely hangs on this hook type piece that sit on the top of a table or any flat surface.
